(19) United States
(12) Patent Application Publication
(10) Pub. No.: US 2004/0234725 A1
(43) Pub. Date: Nov. 25, 2004

(54) Stere-turf reinforcement mat of waterworn preventative

(75) Inventor: Tien-Pao Chiang, Taipei (TW)

Correspondence Address: BACON & THOMAS, PLLC, 625 SLATERS LANE, FOURTH FLOOR, ALEXANDRIA, VA, 22314

(73) Assignee: POLYGLAS APPLIED MATERIALS CO., LTD., TAICHUNG (TW)

(21) Appl. No.: 10/742,821

(22) Filed: Dec. 23, 2003

(30) Foreign Application Priority Data
May 21, 2003 (TW) 92209363

(51) Int. Cl. B32B 1/00; B32B 3/02; B32B 33/00

(52) U.S. Cl. 428/152; 428/85; 428/93; 442/203; 442/205

(57) ABSTRACT

A stere-turf reinforcement mat having a mat body formed of low shrinkage yarns by weaving and a plurality rib lines formed of high shrinkage yarns and arranged the mat body and partially woven through the mat body for causing the mat body to form into wrinkles to show a three-dimensional pattern when heated to cause high shrinkage yarns to shrink.

### BACKGROUND OF THE INVENTION

1. Field of the Invention

The present invention relates generally to construction engineering and, more specifically, to a stere-turf reinforcement mat of waterworn preventative.

2. Description of the Related Art

Regular turf reinforcement mats of waterworn preventative include three types. The first type is a stere mat formed by fastening plastic mat, coconut mat and planar net into a stack. The second type is a stere mat made by spinning. Stere mats of the aforesaid first and second types have big meshes to facilitate growing of plants. However, due to weak silk strength and linking power, stere mats of these two types have a low structural strength and are not suitable for use in steep slopes. The third type is a pyramid-like stere mat made with a single yarn by weaving. A mat of the third type has a relatively higher structural strength. However, its weaving procedure is complicated, resulting in high manufacturing cost. Further, a mat of the third type has small meshes in high density, not in favor of growing of plants.

### SUMMARY OF THE INVENTION

The present invention has been accomplished under the circumstances in view. It is the main object of the present invention to provide a stere-turf reinforcement mat of waterworn preventative, which has a high structural strength, big meshes, low expansibility, high compressive strength, and sharply wrinkled contour. It is another object of the present invention to provide a stere-turf reinforcement mat of waterworn preventative, which is easy and inexpensive to manufacture.

To achieve these and other objects of the present invention, the stere-turf reinforcement mat of waterworn preventative comprises a mat body formed of low contraction yarns by weaving, and a plurality rib lines formed of high contraction yarns and arranged on at least one of top and bottom sides of the mat body and partially woven through the mat body, such that when the high shrinkage yarns are heated to shrink, the mat body is caused to form into wrinkles, forming a stere-turf reinforcement mat.

### BRIEF DESCRIPTION OF THE DRAWINGS

FIG. 1 is a front view of a stere-turf reinforcement mat of waterworn preventative according to the first embodiment of the present invention.

FIG. 2 is a side view of the stere-turf reinforcement mat of waterworn preventative according to the first embodiment of the present invention.

FIG. 3 is a perspective view of the stere-turf reinforcement mat of waterworn preventative according to the first embodiment of the present invention.

FIG. 4 is a front view of the stere-turf reinforcement mat of waterworn preventative according to the second embodiment of the present invention.

FIG. 5 is a side view of the stere-turf reinforcement mat of waterworn preventative according to the second embodiment of the present invention.

FIG. 6 is a perspective view of the stere-turf reinforcement mat of waterworn preventative according to the second embodiment of the present invention.

FIG. 7 is a side view of a stere-turf reinforcement mat of waterworn preventative according to the third embodiment of the present invention.

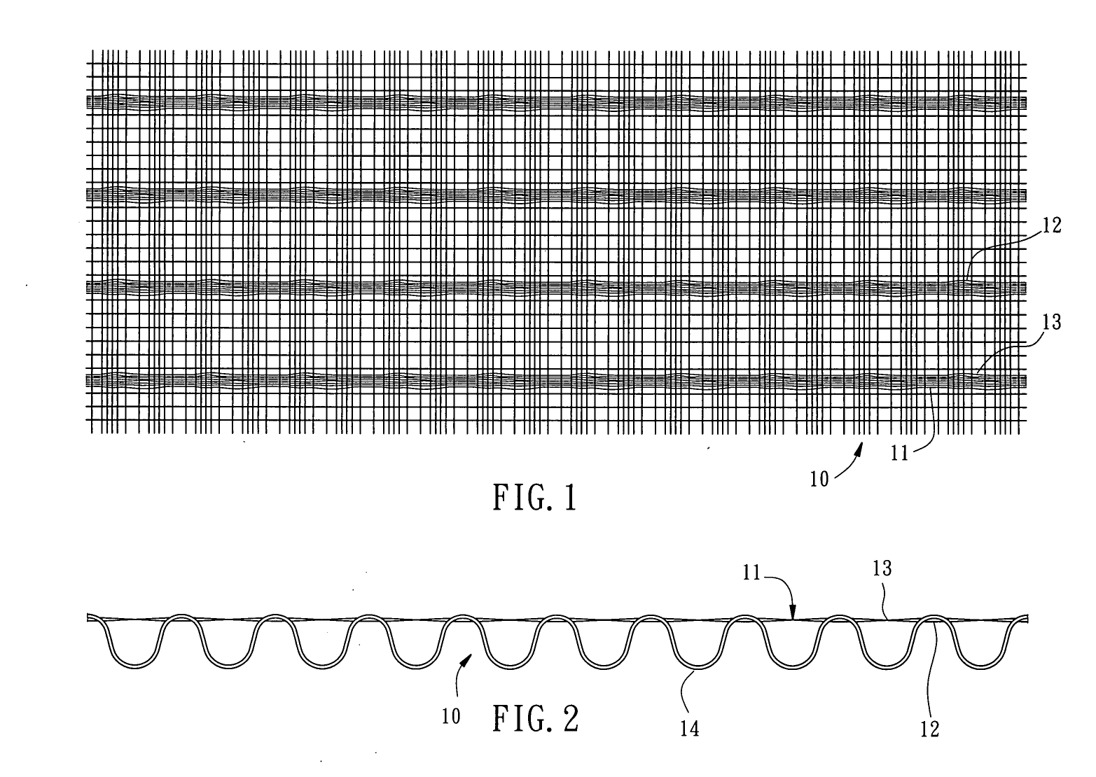

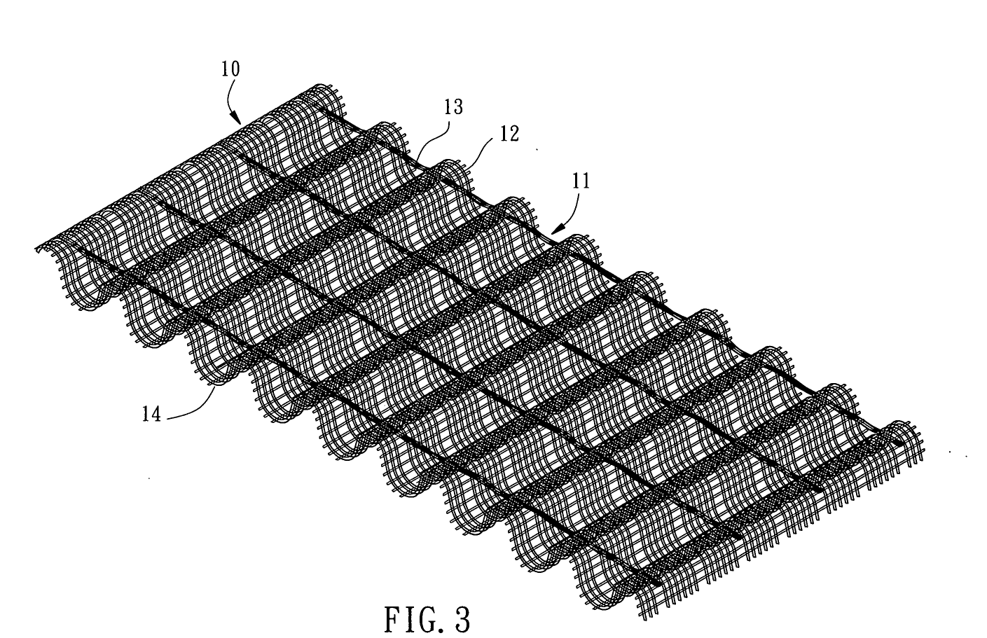

### DETAILED DESCRIPTION OF THE INVENTION

Referring to FIGS. 1˜3, a stere-turf reinforcement mat of waterworn preventative in accordance with the first embodiment of the present invention is shown comprising a mat body 10 formed of low shrinkage yarns by weaving, and a plurality rib lines 11 of high shrinkage yarns arranged in one single axial direction on one side of the mat body 10 and partially woven through the mat body 10.

The rib lines 11 are simultaneously made when weaving low shrinkage yarns into the mat body 10, and partially fastened to the mat body 10 by interweaving. Therefore, the rib lines of high shrinkage yarns and the mat body of low shrinkage yarns form a mat structure having alternatively arranged interwoven portions 12 and non-interwoven portions 13. Thus, the rib lines in the interwoven portions 12 are interconnected with the mat body, and the rib lines in the non-interwoven portions 13 are suspended above the mat body. The mat thus obtained is heated to a predetermined temperature level, causing high shrinkage yarns to shrink. When high shrinkage yarns shrank, the non-interwoven portion 13 between each two adjacent interwoven portions 12 is stretched, thereby causing the mat body 10 to be squeezed to form a corrugated wrinkle pattern 14, and a stere-turf reinforcement mat of waterworn preventative is thus obtained. If rib lines are spaced in longitudinal direction and woven through the mat body in transverse direction, the mat will be caused to form into wrinkles in transverse direction after heat treatment.

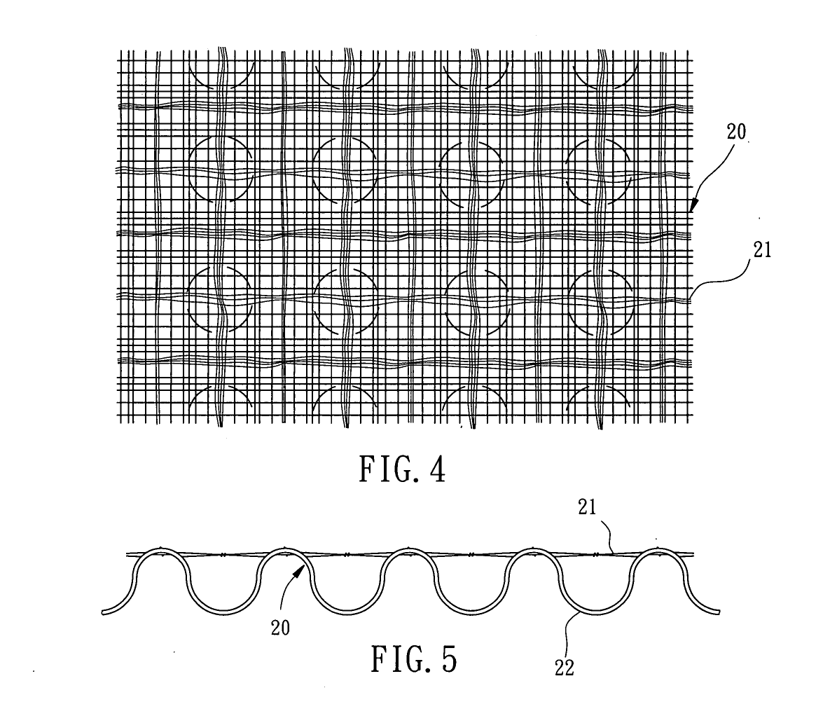

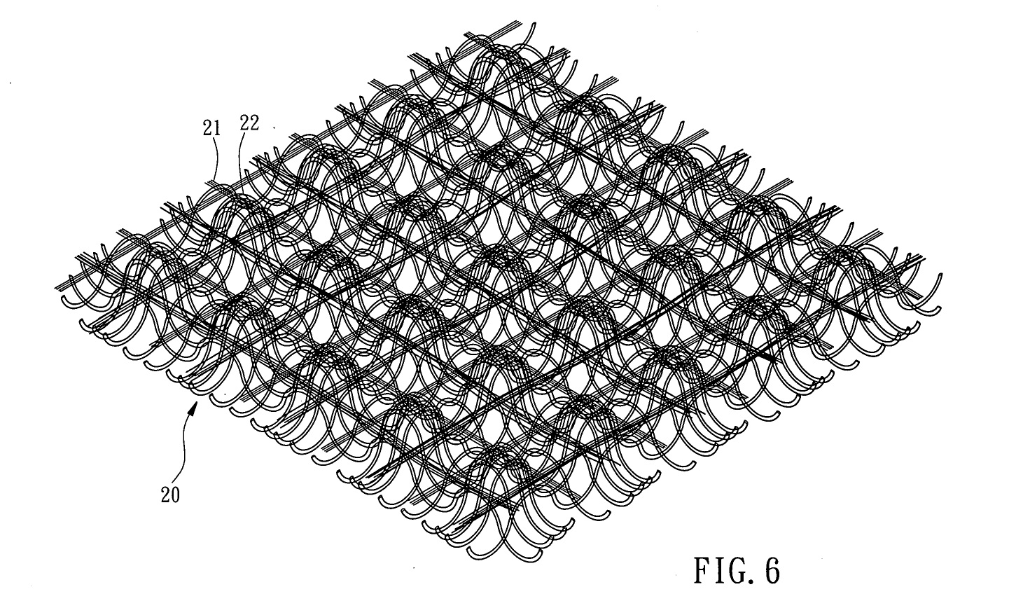

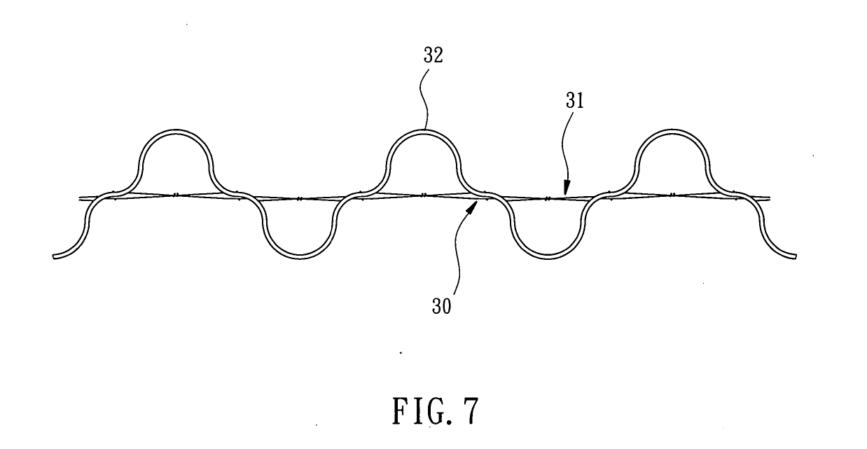

FIGS. 4˜6 show a stere-turf reinforcement mat of waterworn preventative according to the second embodiment of the present invention. According to this embodiment, the stere-turf reinforcement mat comprises a mat body 20 formed of low shrinkage yarns by weaving, and a plurality rib lines 21 of high shrinkage yarns longitudinally and transversely arranged on one side of the mat body 10 and partially woven through the mat body 20. The rib lines are simultaneously made when weaving low shrinkage yarns into the mat body, and partially fastened to the mat body by interweaving. Therefore, the rib lines of high shrinkage yarns and the mat body of low shrinkage yarns form a mat structure having alternatively arranged interwoven portions and non-interwoven portions. The mat thus obtained is then heated to a predetermined temperature level, causing high shrinkage yarns to shrink. Because the rib lines of high shrinkage yarns are intersected and partially woven through the mat body, shrinking of the high shrinkage yarns causes the mat body to wrinkle, and therefore raised portions 22 of chessboard-like pattern are formed in one side of the mat.

FIG. 7 shows a stere-turf reinforcement mat of waterworn preventative according to the third embodiment of the present invention. According to this embodiment, the stere-turf reinforcement mat comprises a mat body 30 formed of low shrinkage yarns by weaving, and a plurality rib lines 31 of high shrinkage yarns longitudinally arranged on one side of the mat body 30 and transversely arranged on the other side of the mat body 30 and respectively partially woven through the mat body 30. After heat treatment, raised portions 32 are alternatively formed on the two opposite sides of the mat body.

Further, the invention can achieve a fire protecting effect by means of the use of a different thread material. For example, the thread material can be made having a core member, and a plastic cover covering the core member. The core member can be made from glass fibers, carbon fibers, or PVC (polyvinyl chloride). Preferably, polyvinyl chloride is used for the cover member. The plastic cover can be selected from PP, PVC, PET, or Nylon. Preferably, PVC is used for the plastic cover. A stere-turf reinforcement mate sample made by using the aforesaid thread material has a better wire protecting function. Following table shows the test result made on stere-turf reinforcement mat samples of the present invention by Taiwan Plastic Industry Development Center through a vertical inflammability test. Through the vertical inflammability test, it proves the good fire protecting effect of the stere-turf reinforcement mate of the present invention.

| | | Test Result | | | | | |
|---|---|---|---|---|---|---|---|
| | | | First | First | Spark | Burning | |
| | | | burning | burning | burning | to | Dropping |
| | | | time | time | time | fixture | and Cotton |
| Test Item | Test Method | Sample | t1(sec) | t2(sec) | t3(sec) | t4(sec) | inflammation |
| Vertical | UL94 | #1 | 16.1 | 54 | 0 | No | No |
| Inflammability | | #2 | 154 | 34 | 0 | No | No |
| Test | | #3 | 12.3 | 3.7 | 0 | No | No |
| | | #4 | 2.1 | 44 | 0 | No | No |
| | | #5 | 8.6 | 15 | 0 | No | No |

Judgment Pass UL94V1 inflammability test
Remarks:
1. Preparation of test sample: shape cutting
2. Test sample status adjustment:
Temperature: 23 ± 2° C.
Relative humility: 50 ± 5%
Time: 48 hours
3. Test direction: vertical direction
4. Average size of test samples:
Length: 123.4˜129.9 mm
Width: 12.5˜13.4 mm
Thickness: 2.03˜2.14 mm
* Test result is judged subject to data obtained after standard status adjustment of test samples.

What is claimed is:

1. A stere-turf reinforcement mat comprising:
a mat body formed of low shrinkage yarns by weaving; and
a plurality rib lines formed of high shrinkage yarns and arranged on at least one of top and bottom sides of said mat body and partially woven through said mat body, such that when said high shrinkage yarns are heated to shrink, said mat body is caused to form into wrinkles, forming a stere-turf reinforcement mat.

2. The stere-turf reinforcement mat as claimed in claim 1, wherein said rib lines extend in one single axial direction and partially woven through said mat body in the same direction.

3. The stere-turf reinforcement mat as claimed in claim 1, wherein said rib lines are arranged on only one side of said mat body.

4. The stere-turf reinforcement mat as claimed in claim 1, wherein said rib lines are longitudinally and transversely arranged on said mat body and partially woven through said mat body.

5. The stere-turf reinforcement mat as claimed in claim 4, wherein said rib lines are arranged on only one side of said mat body.

6. The stere-turf reinforcement mat as claimed in claim 4, wherein said rib lines are longitudinally arranged on a first side of said mat body and transversely arranged on a second side of said mat body.
